(19) United States
(12) Patent Application Publication
(10) Pub. No.: US 2015/0222829 A1
(43) Pub. Date: Aug. 6, 2015

(54) IMAGING APPARATUS

(71) Applicant: HITACHI INDUSTRY & CONTROL SOLUTIONS, LTD., Hitachi-shi (JP)

(72) Inventors: Mayumi NAKADE, Tokyo (JP); Shinichiro HIROOKA, Tokyo (JP); Keisuke KAWAMOTO, Tokyo (JP)

(73) Assignee: HITACHI INDUSTRY & CONTROL SOLUTIONS, LTD., Hitachi-shi (JP)

(21) Appl. No.: 14/598,302

(22) Filed: Jan. 16, 2015

(30) Foreign Application Priority Data
Jan. 31, 2014 (JP) 2014-016352

(51) Int. Cl. H04N 5/357; H04N 9/04

(52) U.S. Cl. CPC H04N 5/3572; H04N 9/045

(57) ABSTRACT

An imaging apparatus includes an imaging unit that outputs an optical image received by an optical unit as an electric signal, according to set imaging parameters; a shading correcting unit that outputs an electric signal obtained by performing shading correction according to the imaging parameters on the electric signal output by the imaging unit; an output unit that outputs the electric signal output from the shading correcting unit; a detecting unit that detects the electric signal output from the shading correcting unit and output brightness information; and a control unit that sets the imaging parameters of the imaging unit and strength of the shading correction by the shading correcting unit, on the basis of the brightness information output by the detecting unit.

### CROSS-REFERENCE TO RELATED APPLICATIONS

This application claims the priority of Japanese Patent Application No. 2014-016352, filed on Jan. 31, 2014, which is incorporated herein by reference in its entirety.

### BACKGROUND OF THE INVENTION

1. Field of the Invention

The present invention relates to an imaging apparatus. 2. Description of the Related Art

As the related art of a field of the present technology, JP-2003-169255-A has been known. In JP-2003-169255-A, it is described that “in a field of a digital camera using a CCD solid-state imaging element or a CMOS sensor for public welfare, because a restriction is large in terms of a cost, a shading correction method capable of ensuring some correction precision at some cost is preferable. However, a preferable method is not suggested for the shading correction method. Therefore, an object of the present invention is to provide a shading correction method and a shading correction apparatus that can perform optimal shading correction at a limited cost (gate number) in a camera system for public welfare”.

### SUMMARY OF THE INVENTION

In JP-2003-169255-A, a difference of shading by a state of a diaphragm of a lens is not considered and there is room for improvement in realizing appropriate shading correction having considered visibility.

An aspect of the present invention provides an imaging apparatus including an imaging unit that outputs an optical image received by an optical unit as an electric signal, according to set imaging parameters; a shading correcting unit that outputs an electric signal obtained by performing shading correction according to the imaging parameters on the electric signal output by the imaging unit; an output unit that outputs the electric signal output from the shading correcting unit; a detecting unit that detects the electric signal output from the shading correcting unit and output brightness information; and a control unit that sets the imaging parameters of the imaging unit and strength of the shading correction by the shading correcting unit, on the basis of the brightness information output by the detecting unit.

The present invention can provide an imaging apparatus that can perform appropriate shading correction and enable visibility to be superior to a peripheral portion of an image.

### BRIEF DESCRIPTION OF THE DRAWINGS

FIG. 1 is a block diagram illustrating an entire configuration of an imaging apparatus according to an embodiment;

FIG. 2 is a block diagram illustrating an example of a configuration of an imaging unit;

FIG. 3 is a diagram illustrating an example of a light amount change of a peripheral pixel;

FIG. 4 is a block diagram illustrating an example of a shading correcting unit;

FIG. 5 is a diagram illustrating an example of block division of a shading correcting unit;

FIG. 6 is a diagram illustrating an example of a difference of a correction amount by a diaphragm of an optical unit;

FIG. 7 is a diagram illustrating an example of a signal level change by a screen position;

FIG. 8 is a diagram illustrating an example of a process flow of shading correction of a control unit;

FIG. 9 is a diagram illustrating an example of shading correction control;

FIG. 10 is a diagram illustrating an example of a process flow of shading correction of a control unit;

FIG. 11 is a block diagram illustrating an entire configuration of an imaging apparatus according to an embodiment;

FIG. 12 is a diagram illustrating an example of a signal level change by a screen position;

FIG. 13 is a block diagram illustrating an entire configuration of an imaging apparatus according to an embodiment; and

FIG. 14 is a block diagram illustrating an example of a shading correcting unit.

### DESCRIPTION OF THE PREFERRED EMBODIMENTS

Hereinafter, embodiments of the present invention will be described using the drawings. Like elements are denoted with like reference numerals and overlapped description is omitted.

### First embodiment

In this embodiment, an example of an imaging apparatus that changes shading correction strength according to a diaphragm of a lens will be described.

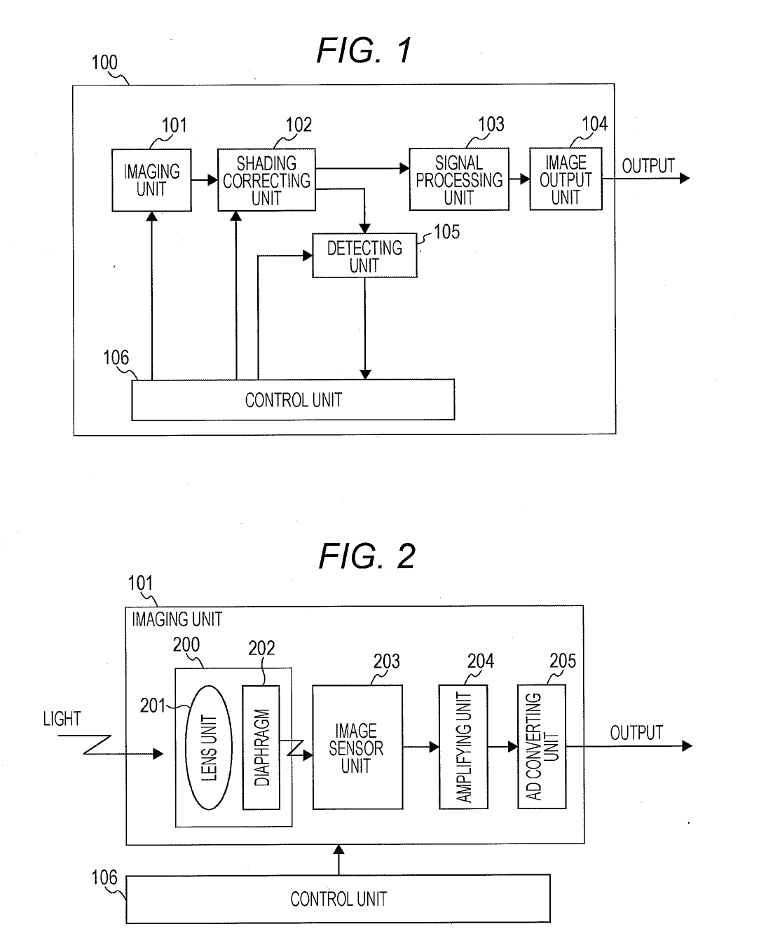

FIG. 1 is a block diagram illustrating an entire configuration of an imaging apparatus according to a first embodiment. 100 shows an imaging apparatus, 101 shows an imaging unit, 102 shows a shading correcting unit, 103 shows a signal processing unit, 104 shows an image output unit, 105 shows a detecting unit, and 106 shows a control unit. Hereinafter, each block will be described.

The imaging unit 101 includes a lens group including an imaging lens, a zoom lens, and a focus lens, a diaphragm, a shutter, an image sensor configured by an imaging element such as a CCD and a CMOS, an amplifier, and an AD converter. The imaging unit 101 executes photoelectric conversion on an optical image received by the image sensor and outputs the optical image as an electric signal.

The shading correcting unit 102 is a block that corrects a signal level decreasing when a peripheral light amount due to the imaging unit 101 decreases. The shading correcting unit 102 includes correction tables in which correction data corresponding to some setting values of a diaphragm to be factors of shading of the imaging unit 101 is stored and an operation processing unit that calculates a correction coefficient of each pixel from correction parameters set by the control unit 106 to be described below and the correction data of the correction tables and executes an operation process of the calculated correction coefficient with an input pixel. The shading correcting unit 102 executes an operation process on the electrical signal from the imaging unit 101 and outputs an electric signal after a shading correction process.

The detecting unit 105 is a block that detects brightness information such as a signal level of video obtained by imaging to acquire determination elements to perform exposure control of the imaging unit 101. As a method of detecting the brightness information, a detection result to be information such as brightness is output from an average value of a signal level of each pixel of an input signal of a region designated from the control unit 106.

The detection method is not limited to the above method and a method capable of determining a level of brightness, such as a method of acquiring a histogram of a signal level and acquiring a level of brightness from a result thereof, a method of acquiring an average value of pixels other than pixels having saturated signal levels and increasing precision of a detection result, and a method of determining a level of brightness according to the number of pixels having saturated signal levels, may be used.

The signal processing unit 103 executes a separation process or a demosaicking process on a signal output by the shading correcting unit 102 and generates a video signal. In addition, the signal processing unit 103 adjusts brightness, contrast, and a color tone of the generated video signal and removes noise, if necessary.

The image output unit 104 converts the received signal into a signal, which can be received by an apparatus to which a signal is output from the imaging apparatus 100, for example, a display device such as a liquid crystal display and a recording device including a storage unit such as a hard disk, and outputs the signal. In addition, when the image output unit 104 is connected by a network, the image output unit 104 converts a format of the signal into a format of a signal corresponding to a transmission method of a moving image, which can be received by the display device, and outputs the signal.

The control unit 106 controls the imaging unit 101 and the shading correcting unit 102, on the basis of the brightness information output by the detecting unit 105. For example, the control unit 106 compares brightness information of a previously set target and the brightness information acquired from the detecting unit 105. If the brightness is insufficient, the control unit 106 determines a diaphragm value, a shutter speed, and a value of gain of the amplifier of the imaging unit 101 such that the brightness approximates to a target value, and sets the determined values to the imaging unit 101.

Here, when the setting values of the imaging unit 101 change a state of shading, for example, change the diaphragm value, the control unit 106 sets correction parameters of the shading correcting unit 102 such that appropriate shading correction is performed. The correction parameters will be described in detail below. If some correction tables corresponding to the diaphragm exist in the shading correcting unit 102, the correction parameters include selection IDs of two correction tables corresponding to diaphragm values with the diaphragm value set to the imaging unit 101 therebetween, an interpolation coefficient to calculate correction data corresponding to the set diaphragm value from correction data of the selected correction tables, and correction strength to determine strength of the shading correction to designate a ratio of an influence on an input pixel by the calculated correction data.

Here, the correction strength is calculated from a maximum correction amount in the set diaphragm value and an allowable maximum correction amount. The allowable maximum correction amount is determined from image quality of an output image of the imaging apparatus 100 for a portion in which a correction amount is large, for example, brightness, a color tone, noise, and resolution and is previously set.

For example, when the maximum value of the correction amount is not more than the previously set maximum value, if a subject has uniform illuminance, the control unit 106 increases the correction strength such that an output signal level of the shading correction becomes uniform and when the maximum value of the shading correction amount is more than the previously set maximum value, the control unit 106 decreases the correction strength. Thereby, the control unit 106 prevents visibility from being deteriorated.

In an imaging apparatus of a monitoring camera, exposure control is performed such that video having superior visibility can be obtained at all times, even though an external light amount greatly changes from the night to the daytime. In the exposure control of the imaging apparatus, exposure conditions such as the diaphragm or the shutter speed of the optical lens and the gain are controlled. For the monitoring camera, it is necessary to image a moving subject at low illuminance and a light amount is maximally obtained. For this reason, the monitoring camera is generally used in a state in which the diaphragm of the lens is close to an open end.

If the diaphragm of the lens comes close to the open end, an amount of shading of an imaging image occurring when a light amount of a peripheral portion is smaller than a light amount of a center portion increases. In an expensive lens, a mechanism for preventing the shading from occurring is provided. However, in an imaging apparatus manufactured at a limited cost, the expensive lens cannot be used and large shading often occurs. In addition, in the lens for the monitoring camera, a zoom lens having high magnification and a wide-angle lens are often used, which results in causing the large shading. For this reason, if the shading correction is performed perfectly on an output image, visibility may be deteriorated, for example, brightness of a peripheral portion or gradation of a color may decrease, resolution may decrease, or a noise amount may increase.

As described above, in the imaging apparatus 100 according to the present invention, the control unit 106 determines the diaphragm value of the imaging unit from the output information of the detecting unit 105 and the appropriate shading correction is enabled according to the set diaphragm value. Therefore, an imaging apparatus that can obtain superior visibility even when shading occurs in an imaging unit can be provided.

Hereinafter, an example of each portion configuring the imaging unit 101 will be described in detail using the drawings.

FIG. 2 is a diagram illustrating an example configuration of the imaging unit 101. The same components as those in FIG. 1 are denoted with the same reference numerals. The imaging unit 101 includes an optical unit 200 including a lens unit 201 and a diaphragm 202, an image sensor unit 203, an amplifying unit 204 that amplifies a signal level, and an AD converting unit 205 that converts an analog signal into a digital signal. The lens unit 201 is a lens group including an imaging lens, a zoom lens, and a focus lens, for example. The lens unit 201 opens/closes the diaphragm 202 and adjusts an amount of light output from the optical unit 200. In addition, an infrared light cut filter cutting infrared light may be provided in the lens unit 201 to improve color reproducibility.

The light incident on the imaging unit 101 is incident on the image sensor unit 203 through the optical unit 200. In the image sensor unit 203, the control unit 106 executes photoelectric conversion and outputs a signal corresponding to an amount of light received by the image sensor unit 203. The amplifying unit 204 amplifies the signal output from the image sensor unit. The AD converting unit 205 converts an analog signal amplified by the amplifying unit 204 into a digital signal.

A level of the signal output from the imaging unit 101 is controlled by adjusting the diaphragm 202 of the optical unit 200, the exposure time of the image sensor unit 203, and the gain of the amplifying unit 204, for example. For the monitoring camera imaging a dark subject at the night, because the exposure time of the image sensor unit 203 is shorter than a frame rate of an image in a moving image, imaging is performed generally after the diaphragm of the optical unit 200 is opened and the gain of the amplifying unit 204 is increased.

If the diaphragm of the optical unit is opened, aberration in which a variation is generated in a level of a signal output from the imaging unit or brightness irregularities such as shading to be reduction of a light amount of a peripheral portion for a light amount of a center portion occur even though the imaging unit images a subject of which an entire surface is uniformly illuminated with light. In the monitoring camera, the brightness irregularities occur easily due to adoption of a zoom lens having high magnification, a wide-angle lens to image a wide range, or an inexpensive lens.

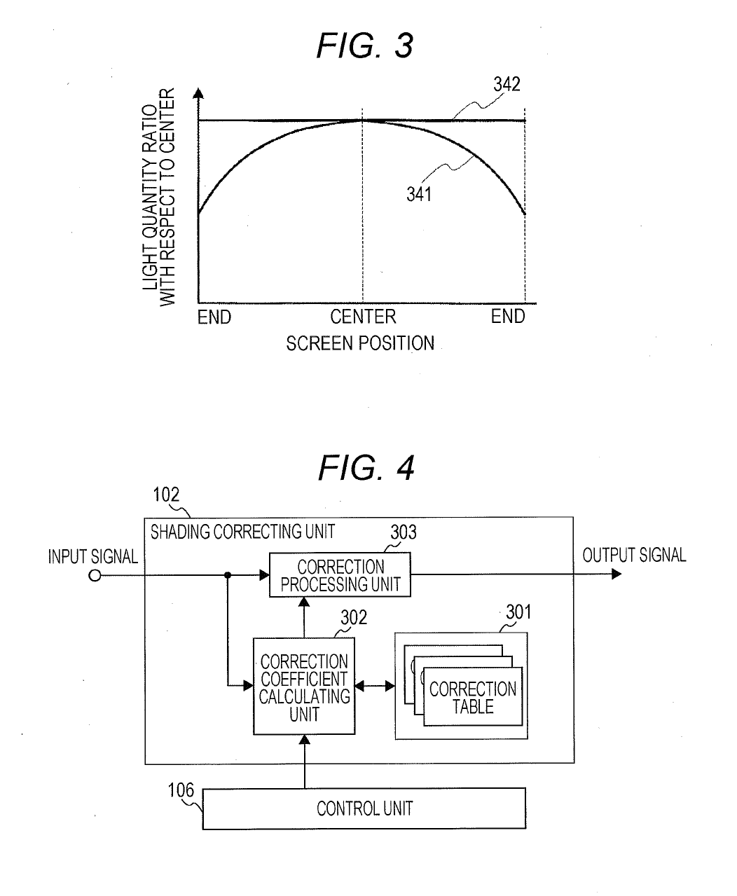

FIG. 3 illustrates a light quantity ratio with respect to a center output from the optical unit 200 when a subject having uniform illuminance is imaged. In FIG. 3, a horizontal axis shows a screen position when an output signal of the imaging unit 101 is displayed on a display device. 341 shows a light amount distribution when the diaphragm 202 is positioned at an open end and 342 shows a light amount distribution when the diaphragm 202 is positioned at a close end (particular, a state in which the diaphragm is narrowed and imaging is performed). In the light amount distribution 342 when the diaphragm is positioned at the close end, light amounts of a center portion and a peripheral portion are almost equal to each other. However, in the light amount distribution 341 in which the diaphragm is positioned at the open end, the light amount of the peripheral portion is smaller than the light amount of the center portion. Shading correction according to the present invention that corrects shading of the imaging apparatus 100 caused by the light amount difference occurring in the optical unit 200 will be described below.

An example of the shading correcting unit 102 will be described in detail below using the drawings.

FIG. 4 is a diagram illustrating a configuration of the shading correcting unit 102. The same components as those in FIG. 1 are denoted with the same reference numerals.

For example, the shading correcting unit 102 includes a correction data table 301 to perform correction according to a screen position and a diaphragm value, a correction coefficient calculating unit 302 to calculate a correction coefficient of each pixel from a correction table, and a correction processing unit 303 to multiply the correction coefficient and input pixel data.

The correction data table 301 stores a plurality of correction tables. In each correction table, a shading correction amount is set as correction data, according to shading occurred by the screen position or the diaphragm of the lens. The correction data that is stored in the correction data table 301 does not need to be correction data corresponding to all pixels. For example, a screen is divided into blocks, correction data of pixels corresponding to vertexes of each block is stored, an interpolation process using the correction data of the vertexes of each block is executed according to a position of each pixel, and correction data of each pixel is calculated.

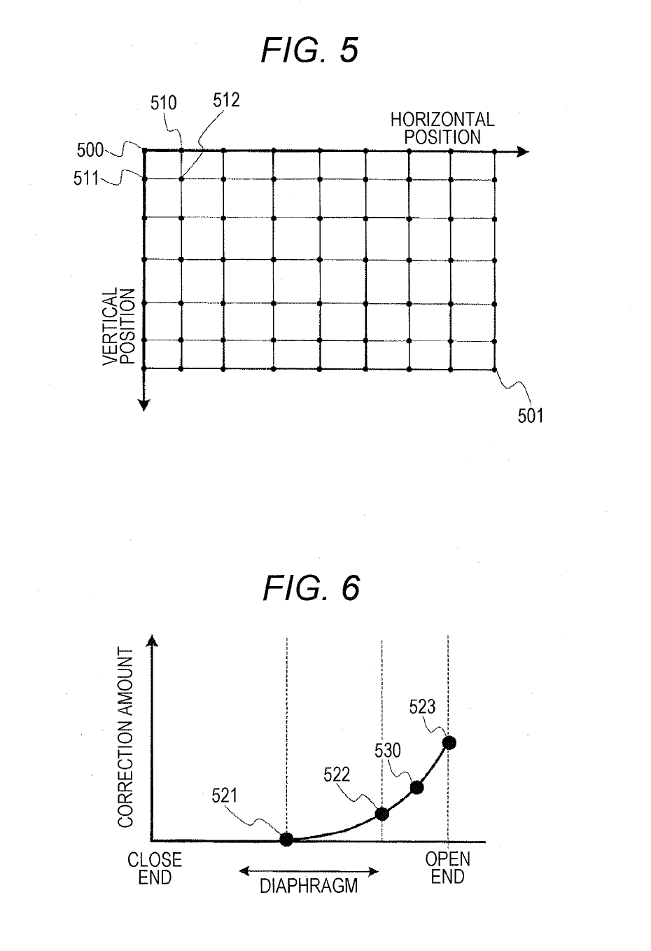

FIG. 5 illustrates a block division example of the case in which a screen is divided into 48 blocks of 8 blocks in a horizontal direction×6 blocks in a vertical direction. 500 shows a coordinate position of a pixel of an upper left end of the screen, 501 shows a position of a pixel of a lower right end of the screen, and the coordinate position 500 and 510, 511, and 512 show coordinate positions of pixels of vertexes of a block of an uppermost left end. In the division example, correction data for every vertex of each block, that is, a total of 63 correction data of 9 correction data in a horizontal direction×7 correction data in a vertical direction are stored in the correction data table 301. Correction data of pixels other than the pixels of each vertex is calculated by determining the block to which the pixel belongs from the position of the pixel, weighting the correction data of each vertex of the block to which the pixel belongs according to a distance from the calculated pixel to each vertex, and adding the correction data.

Here, when the calculated pixel is at an equal distance from all coordinates of the coordinate positions 500, 510, 511, and 512, an average value of the correction data of the coordinate position 500, the correction data of the coordinate position 510, the correction data of the coordinate position 511, and the correction data of the coordinate position 512 becomes correction data of the calculated pixel.

The block example of the screen has been described. However, the block division numbers in the horizontal direction and the vertical direction are exemplary and the present invention is not limited thereto. The width and the height of each block do not need to be the same width and the same height. The horizontal coordinates and the vertical coordinates of each block may be stored at the same time and the widths or the heights of one or more blocks from the upper, lower, left, and right ends in which the correction data greatly changes may be set to small values and the widths or the heights of the other blocks in which the correction data does not greatly change may be set to large values. Alternatively, the widths may be increased in order from the blocks of the left and right ends to the blocks of the center portion and the heights may be increased in order from the blocks of the upper and lower ends to the blocks of the center portion. Thereby, interpolation can be performed with high precision. In the example of FIG. 5, the heights of the blocks in which the coordinate positions 500, 510, 511, and 512 are included are smaller than the heights of the blocks of about the center of FIG. 5.

In the correction data table 301, correction tables corresponding to all diaphragm values are not provided. For example, interpolation can be performed from correction tables corresponding to different diaphragm values. FIG. 6 illustrates an example of the case in which the correction data stored in the correction data table 301 of the certain pixel, for example, the coordinate position 500 and the interpolated correction data are graphed. In FIG. 6, a horizontal axis shows a position of the diaphragm 202 between the open end and the close end, that is, a diaphragm value and a vertical axis shows a correction amount.

In FIG. 6, correction tables corresponding to three diaphragm values are stored and 521, 522, and 523 show correction data stored in the correction tables. For example, the correction data 521 is stored in a correction table of a diaphragm setting value A, the correction data 522 is stored in a correction table of a diaphragm setting value B, and the correction data 523 is stored in a correction table of a diaphragm setting value C. 530 shows an example of interpolation correction data calculated by the correction coefficient calculating unit 302. The interpolation correction data 530 is calculated by the correction parameters set by the control unit 106 and the correction data of the correction table. The correction parameters include a correction table ID to identify the correction table and a weight coefficient.

For the correction table ID, when the setting value of the diaphragm 202 set to the imaging unit 101 by the control unit 106 is between the diaphragm setting value B and the diaphragm setting value C, the control unit 106 selects a correction table ID of the diaphragm setting value B and a correction table ID of the diaphragm setting value C. For the weight coefficient, the control unit 106 determines the weight coefficient from a ratio of a difference of the setting value of the diaphragm 202 and the diaphragm setting value B and a difference of the setting value of the diaphragm 202 and the diaphragm setting value C. For example, in the case of the coordinate position 500 of the calculated pixel, the interpolation correction data 530 is calculated by multiplying the correction data 522 of the correction table of the diaphragm setting value B and the correction data 523 of the correction table of the diaphragm setting value C with the weight coefficient set by the control unit 106 and adding values. In addition, when the calculated pixel is the pixel other than the pixel of the vertex of the block described in FIG. 6, the interpolation correction data is calculated by acquiring the correction data of the diaphragm setting value B and the correction data of the diaphragm setting value C corresponding to the coordinate positions and multiplying the correction data with the weight coefficient.

Similar to the interpolation correction data 530 described above, interpolation correction data is acquired for each pixel in the correction coefficient calculating unit 302 and the interpolation correction data is multiplied with the input signal in the correction processing unit 303 using the interpolation correction data as the correction coefficient. As a result, ideal shading correction to make an entire screen have the same brightness is enabled when a subject having uniform illuminance is imaged.

The example of the case in which the correction table is provided for each of the three diaphragm setting values has been described. However, the number and the interval are exemplary and the present invention is not limited to the number.

The correction coefficient calculating unit 302 of the shading correcting unit 102 sets the correction strength to the calculated correction data and performs appropriate shading correction even when the signal level of the peripheral portion greatly decreases. Hereinafter, a setting example of the correction strength will be described.

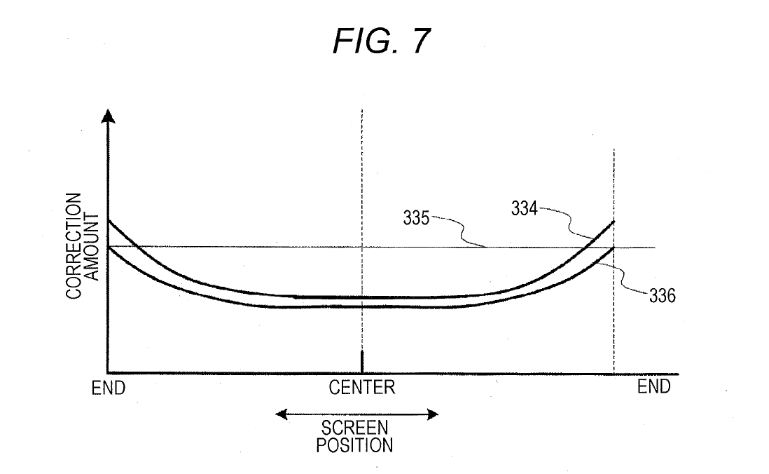

FIG. 7 illustrates the case in which an example of the interpolation correction data is graphed. In FIG. 7, a horizontal axis shows a screen position of a horizontal direction and 334 shows a correction amount of one line of a horizontal direction including a pixel in which a light amount difference with a center portion is largest in a certain diaphragm setting value of the diaphragm 202 of the optical unit 200 and shows a correction amount necessary to display each pixel at the same brightness as the center portion. 335 shows a maximum value of the set shading correction amount and 336 shows a correction amount in the case in which the shading correction strength of the correction amount 334 is restricted.

The maximum value 335 of the set shading correction amount is different according to the imaging unit 101 to be actually used. A maximum allowance value is determined from image quality of an output image of the imaging apparatus 100 for a portion in which a correction amount is large, for example, brightness, a color tone, noise, and resolution and is previously set. In the case in which the correction amount 334 when ideal shading correction to make brightness of an entire screen uniform is performed becomes larger than the maximum value 335 of the set shading correction amount, if the shading correction of the correction amount 334 is performed, it is anticipated that the image quality is deteriorated in the peripheral portion. For this reason, the control unit 106 determines the correction strength such that the maximum value of the correction amount 334 becomes the maximum value of the set shading correction and sets the correction strength to the shading correcting unit 102. In the correction coefficient calculating unit 302 of the shading correcting unit 102, the correction amount 334 and the correction strength are multiplied and the correction amount 336 is acquired. In the correction processing unit 303, the correction amount 336 is multiplied with an input signal using the correction amount 336 as the correction coefficient. The shading correction having considered the image quality of the peripheral portion is enabled by the shading correcting unit described above.

In the above description, the correction method in which the uniform strength is set to the entire surface is described. However, in the portion of the correction amount 334 more than the maximum value 335 of the set shading correction amount, the correction amount may be set to the maximum value 335 of the set shading correction amount and only the peripheral portion may be restricted. In this case, a step of the brightness may occur on the screen. However, a process may be simplified.

Because the appropriate shading correction is enabled by the shading correcting unit 102 described above, an imaging apparatus in which visibility is superior even though shading occurs in an imaging unit can be provided.

A process flow of the control unit 106 of the imaging apparatus 100 described above will be described hereinafter.

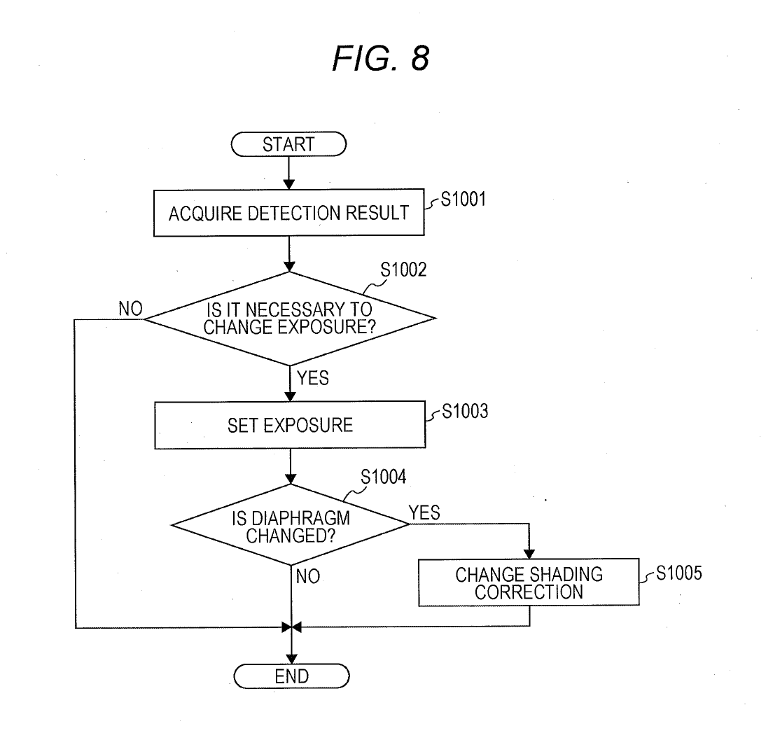

FIG. 8 illustrates an example of the process flow of the shading correction control of the control unit 106. In step S1001, the control unit 106 acquires the detection result such as the brightness information from the detecting unit 105 and the process proceeds to step S1002. In step S1002, the control unit 106 compares the acquired detection result and the exposure target value to be the target value of the brightness information making expectations on the detection result. If the detection result of the detecting unit 105 is in a range of the exposure target value, the control unit 106 ends the process. When the detection result of the detecting unit 105 is out of the range of the exposure target value, the process proceeds to step S1003.

In step S1003, the control unit 106 determines the diaphragm value, the shutter speed, and the gain value of the amplifier to be the imaging conditions of the imaging unit 101, from a deviation amount from the exposure target value. For example, when the control unit 106 determines that the brightness is larger than the exposure target value, from the detection result of the detecting unit 105, the control unit 106 decreases the diaphragm value, increases the shutter speed, or decreases the gain value, according to the difference of the brightness. When the control unit 106 determines that the brightness is smaller than the exposure target value, from the detection result, the control unit 106 increases the diaphragm value, decreases the shutter speed, or increases the gain value, according to the difference of the brightness.

Here, when the diaphragm value is not changed, in step S1004, the control unit 106 determines that the shading amount is not changed and ends the process. In addition, when the diaphragm value is changed, the shading amount is also changed. Therefore, the process proceeds to step S1005. In step S1005, the control unit 106 determines the parameters set to the shading correcting unit 102, sets the parameters to the shading correcting unit, and ends the process.

The above process is executed repetitively during imaging and the exposure control of the imaging unit 101 or the correction control of the shading correcting unit 102 is controlled appropriately by the illuminance of the subject.

In addition, when the change speed of the diaphragm of the imaging unit 101 is slow or the change speed of the diaphragm value is slow for oscillation prevention of the exposure control, the control unit 106 performs the determination and the setting of the correction parameters of the shading correcting unit 102, such that the correction amount of the shading correcting unit 102 becomes a ratio corresponding to the diaphragm of the imaging unit.

As described above, in the imaging apparatus 100 according to the present invention, the control unit 106 determines the diaphragm value of the imaging unit from the output information of the detecting unit 105 and the shading correction corresponding to the set diaphragm value is enabled. Therefore, an imaging apparatus in which the shading correction corresponding to the exposure control is enabled can be provided.

In the above description, the correction of the brightness of the shading correcting unit 102 is described. However, a shading characteristic may be different for each color, according to characteristics of the lens and the sensor. In this case, in the shading correcting unit 102, the correction table data is prepared for each color of an electric signal output from the imaging unit 101, for example, each color of red, blue, and green, the correction table data to calculate the correction coefficient is switched for each pixel, and the appropriate shading correction can be performed for each color. As a result, the aberration of the colors or the color irregularities can be improved. Second embodiment

In this embodiment, an imaging apparatus that determines correction strength of a shading correcting unit 102 according to gain of an amplifying unit of an imaging unit 101 will be described.

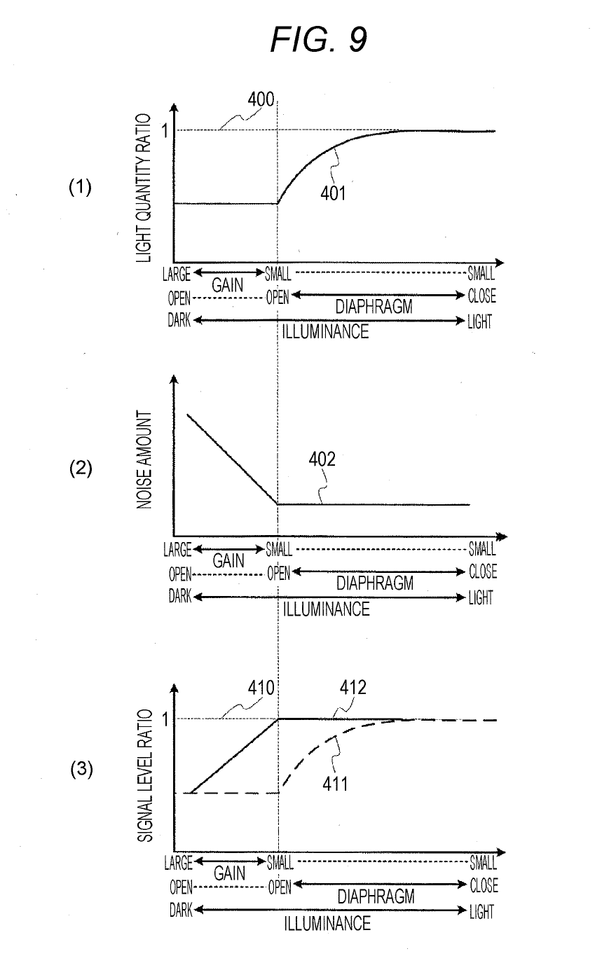

Control of the shading correcting unit 102 when gain of an amplifier of the imaging unit 101 is changed by exposure control will be described. FIG. 9 illustrates (1) a change example of a light quantity ratio of a certain peripheral portion pixel with respect to a center portion pixel, (2) a change example of noise amounts of the certain peripheral portion pixel and the center portion pixel, and (3) a change example of a signal level ratio of the certain peripheral portion pixel for the center portion pixel output from the shading correcting unit 102, when illuminance of a subject having uniform illuminance is changed and the subject is imaged by the imaging unit 101.

400 of (1) shows a light quantity ratio of the center portion pixel and 401 shows a light quantity ratio of the certain peripheral portion pixel. In the light quantity ratio 401 of the peripheral portion pixel, light amounts of the center portion and the peripheral portion are almost equal to each other, in a place where the illuminance is high. If the illuminance decreases and a diaphragm is opened by exposure adjustment, a difference increases for the light quantity ratio 400 of the center portion pixel and a light amount difference is maximized when the diaphragm is positioned at an open end. If the illuminance decreases, the gain of the amplifying unit increases in the imaging unit 101. In the gain of the amplifying unit, because there is no difference in the center portion pixel and the peripheral portion pixel, the light quantity ratio becomes constant. Meanwhile, if the gain of the amplifying unit increases, the noise increases.

402 of (2) shows noise amounts of the peripheral portion pixel and the center portion pixel. Because the noise amount is not changed even though the diaphragm is changed, the noise amount is constant in the illuminance controlled in the diaphragm. However, if the gain of the amplifier increases, the noise increases. Here, in the case in which the noise amount increases, if the signal level of the peripheral portion is amplified by the shading correcting unit 102, the noise is further amplified, the distribution difference of the noise is more than a shading correction effect, and the noise is more visible than the shading. Therefore, the correction strength of the shading correcting unit 102 is decreased according to the noise amount.

410 of (3) shows a signal level of the center portion pixel, 411 shows a signal level of the peripheral portion pixel input to the shading correcting unit 102, and 412 shows a signal level of the peripheral portion pixel output from the shading correcting unit 102. In the signal level 412 of the peripheral portion pixel, when the gain of the amplifier decreases, the strength of the shading correcting unit is increased, the correction is performed such that the signal level of the peripheral portion pixel is almost equal to the signal level of the center portion pixel, the shading is corrected almost perfectly, the correction strength of the shading correcting unit 102 is decreased according to the gain increase, and the amplification of the noise is prevented.

By the control of the shading correcting unit 102 described above, in the image in which it is anticipated that the noise increases, the shading correction strength is decreased, the amplification of the noise is suppressed, and an image having superior visibility can be obtained.

In the control example of the shading correcting unit 102, when the exposure control is in a range controlled in the diaphragm, the strength of the shading correcting unit 102 is made to be constant. However, when it is anticipated that the noise of the peripheral portion is increased by the correction of the shading correcting unit 102 and the visibility is deteriorated, as described in the first embodiment, the control to decrease the correction strength of the shading correcting unit 102 may be performed before the diaphragm is positioned at the open end.

A process flow of the control unit 106 of the imaging apparatus 100 described above will be described hereinafter.

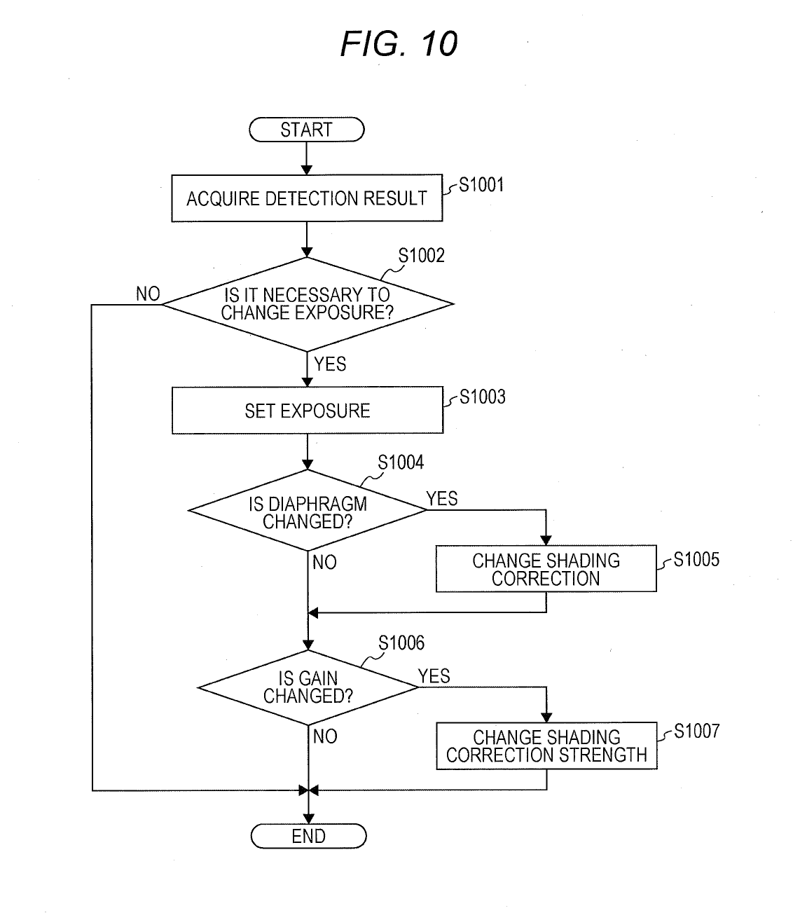

FIG. 10 illustrates an example of a process flow of the shading correction control of the control unit 106. The same components as those in FIG. 8 are denoted with the same reference numerals and description thereof is omitted.

After the process of step S1004 or S1005, in step S1006, the control unit 106 determines whether the gain of the amplifier of the imaging unit 101 is changed. When the gain is not changed, the control unit 106 ends the process and when the gain is changed, the process proceeds to step S1007. In step S1007, the control unit 106 determines the appropriate strength set to the shading correcting unit 102, from the gain of the amplifier of the imaging unit 101, sets the appropriate strength to the shading correcting unit 102, and ends the process.

As described above, in the imaging apparatus 100 according to the present invention, the control unit 106 determines the diaphragm value of the imaging unit from the output information of the detecting unit 105 and the shading correction corresponding to the set diaphragm value is enabled. Therefore, an imaging apparatus in which the shading correction corresponding to the exposure control is enabled can be provided.

### Third Embodiment

In this embodiment, an imaging apparatus that corrects a detection result of a detecting unit according to strength of shading correction will be described.

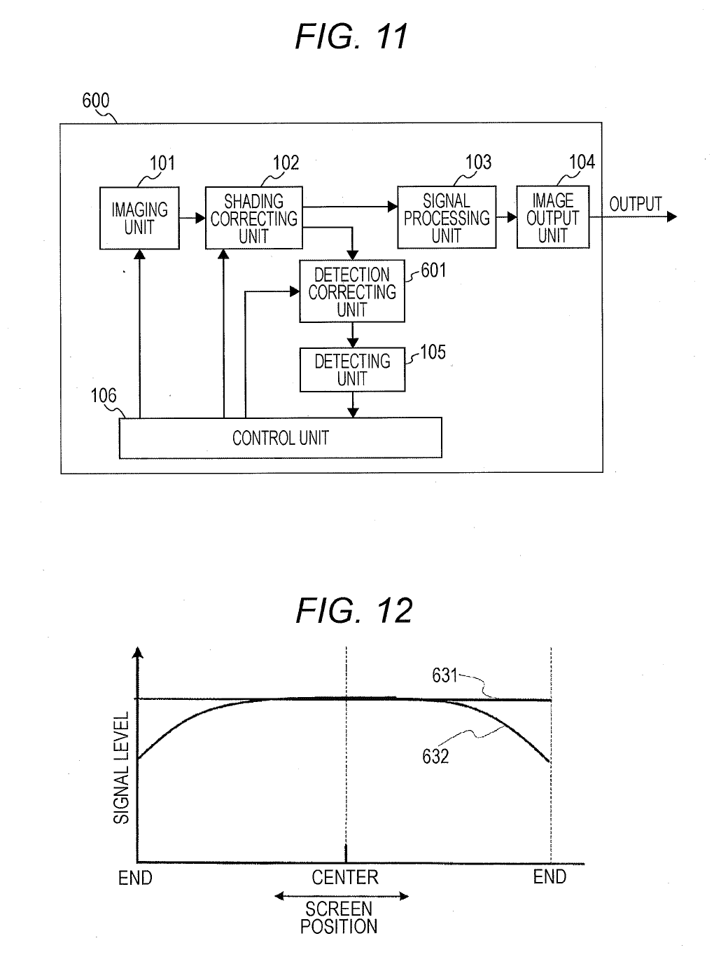

FIG. 11 is a block diagram illustrating an entire configuration of an imaging apparatus 600 according to a third embodiment. The same components as those in FIG. 1 are denoted with the same reference numerals and description thereof is omitted.

601 shows a detection correcting unit. When a correction amount of a shading correcting unit 102 is insufficient for a shading amount of an imaging unit 101, the detection correcting unit 601 complements an insufficient amount in a signal level of a signal output from the shading correcting unit and outputs the signal to the detecting unit 105. The correction amount of the detection correcting unit 601 will be described using FIG. 12.

FIG. 12 is a diagram illustrating an example of a horizontal position of a screen and a signal level output from the shading correcting unit 102. 631 shows a signal level when the correction strength is maximized and correction is performed such that an entire screen has uniform brightness at the time of imaging a subject having uniform illuminance and 632 shows a signal level when the correction strength is decreased in consideration of deterioration of image quality of a peripheral portion.

For example, in the case in which ideal shading correction to make the entire screen have the uniform brightness is performed, if a control unit 106 is set such that exposure adjustment of the imaging unit 101 by the control unit 106 is stabilized, when a signal on which shading correction is performed to have the signal level 632 is input to the control unit 106 through the detecting unit 105, feedback control of exposure adjustment by the control unit 106 and shading correction by the shading correcting unit 102 are changed and become unstable.

Therefore, the detection correcting unit 601 performs correction such that the signal level 632 output by the shading correcting unit 102 described above becomes the signal level 631 and outputs the signal level to the detecting unit 105. The signal level input to the detecting unit 105 becomes equal to brightness information in a state in which the ideal shading correction to make the entire screen have the uniform brightness is performed at all times.

A configuration of the detection correcting unit 601 is the same as the configuration of the shading correcting unit 102 and the same correction parameters as those in the shading correcting unit 102 are set from the control unit 106. In the detection correcting unit 601, a detection correction coefficient to complement an insufficient amount of a correction amount is calculated from the correction strength of the correction parameters set to the control unit 106 and the detection correction coefficient is used, instead of the correction strength. By the detection correcting unit 601 described above, the signal level 632 can be changed to the signal level 631 obtained by performing the ideal shading correction to make the entire screen have the uniform brightness on the output of the detection correcting unit 601. The calculation of the correction strength of the detection correcting unit 601 is not limited to the calculation by the process in the detection correcting unit and may be executed by the control unit 106. In addition, a correction data table 301 of the shading correcting unit 102 can be shared with other blocks. In the detection correcting unit 601, the correction table of the shading correcting unit 102 may be used.

In addition, in the detection correcting unit 601 that does not affect visibility, correction does not need to be performed with the same resolution as that in the shading correcting unit 102 and the number of blocks dividing the screen may be smaller than that in the shading correcting unit 102. Instead of a correction coefficient of a unit of a pixel, a correction coefficient of a unit of a block may be calculated and may be used as a uniform correction coefficient in the block. As such, the number of blocks is decreased, so that a correction data amount and an operation amount can be decreased.

As described above, in the present invention, because the signal when the ideal shading correction to make the entire screen have the uniform brightness is performed at all times is input to the detecting unit, stabilized exposure control is enabled, regardless of the strength of the shading correction. Fourth embodiment

In this embodiment, an imaging apparatus that performs appropriate shading correction when there are factors causing a plurality of shading corrections will be descried.

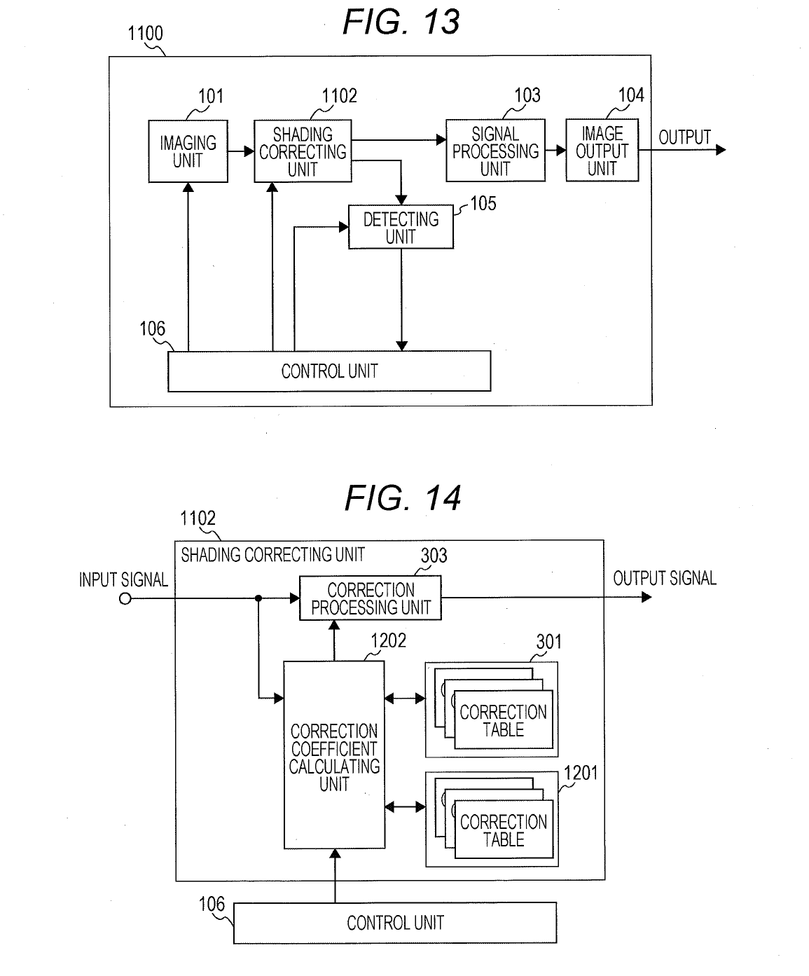

FIG. 13 is a block diagram illustrating an entire configuration of an imaging apparatus 1100. The same components as those in FIG. 1 are denoted with the same reference numerals and description thereof is omitted. 1102 shows a shading correcting unit corresponding to when there are a plurality of factors for shading and the details thereof will be described using FIG. 14. FIG. 14 is a block diagram illustrating an example of the shading correcting unit 1102. 1201 shows a correction table group of setting parameters of an imaging unit 101 other than a diaphragm. For example, in the correction table group, a correction table according to a zoom value of a zoom lens is stored. In the zoom lens, a shading amount is small at a zoom end of the zoom lens and the shading amount is large at a wide end. 1202 shows a correction coefficient calculating unit and the correction coefficient calculating unit calculates a correction coefficient to correct an input signal from a correction data table 301, the correction table 1201, and parameters for correction set by a control unit 106.

The correction parameters set by the control unit 106 include an ID of a correction table selected from the correction data table 301 of the diaphragm, according to a setting value of the imaging unit 101, an interpolation coefficient for the diaphragm to calculate correction data corresponding to a diaphragm value set from correction data of the selected correction table, a correction table ID selected from the correction table 1201 of the zoom, an interpolation coefficient for the zoom to calculate correction data corresponding to a zoom value set from correction data of the selected correction table, and correction strength. The correction coefficient calculating unit 1202 calculates the correction data of the diaphragm from the correction table and the interpolation coefficient of the diaphragm, calculates the correction data of the zoom from the correction table and the interpolation coefficient of the zoom, and calculates the correction coefficient from the correction data of the diaphragm, the correction data of the zoom, and the correction strength.

By the shading correcting unit 1102 described above, an imaging apparatus that can perform appropriate shading correction in shading correction in which there are a plurality of factors can be provided.

In the above description, the two factors of the diaphragm and the zoom are described. However, even when factors causing the shading or the brightness irregularities, such as sensitivity irregularities of a focus lens or a sensor increase, correspondence is enabled by increasing correction tables and performing the same control.

What is claimed is:

1. An imaging apparatus comprising:
an imaging unit that outputs an optical image received by an optical unit as an electric signal, according to set imaging parameters;
a shading correcting unit that outputs an electric signal obtained by performing shading correction according to the imaging parameters on the electric signal output by the imaging unit;
an output unit that outputs the electric signal output from the shading correcting unit;
a detecting unit that detects the electric signal output from the shading correcting unit and output brightness information; and
a control unit that sets the imaging parameters of the imaging unit and strength of the shading correction by the shading correcting unit, on the basis of the brightness information output by the detecting unit.

2. The imaging apparatus according to claim 1, wherein the imaging parameters of the imaging unit include a parameter to control gain or a diaphragm.

3. The imaging apparatus according to claim 2, wherein the shading correcting unit has correction tables in which correction data according to screen position information corresponding to a plurality of diaphragms is stored and the shading correcting unit complements correction data other than the stored diaphragms and generates data.

4. The imaging apparatus according to claim 1, wherein a detecting unit correcting unit to correct an input signal level is provided in the detecting unit and the control unit sets correction strength of the detecting unit correcting unit according to the strength set to the shading correction.

5. The imaging apparatus according to claim 1, wherein correction tables stored in the shading correcting unit include a correction table different for each color output by the imaging unit.
